(19) United States
(12) Patent Application Publication
(10) Pub. No.: US 2019/0085919 A1
(43) Pub. Date: Mar. 21, 2019

(54) BICYCLE CALIPER

(71) Applicant: TZU-HUNG YANG, Taichung City (TW)

(72) Inventor: TZU-HUNG YANG, Taichung City (TW)

(21) Appl. No.: 15/707,211

(22) Filed: Sep. 18, 2017

(51) Int. Cl. F16D 55/2255; F16D 65/18; B62L 1/00

(52) U.S. Cl. CPC F16D 55/2255; F16D 2055/002; B62L 1/005; F16D 65/18

(57) ABSTRACT

A bicycle caliper is provided, including a base body having a caliper braking area, two caliper brake units and two swinging units. Each caliper brake unit includes a rotating plate rotatably positioned within the base body, a braking plate, at least one driving mechanism and a first connecting member which is movable along an axis and disposed through and connected to the rotating plate, the braking plate is screwed with the first connecting member to be in co-movement relation, the braking plate is located between the rotating plate and the caliper braking area, and the at least one driving mechanism is disposed between the rotating plate and the braking plate. Each swinging unit includes a swinging portion and a second connecting member, the swinging portion is connected to the rotating plate via the second connecting member to be in co-rotation relation.

### BACKGROUND OF THE INVENTION

### Field of the Invention

The present invention relates to a bicycle caliper.

### Description of the Prior Art

There are many types of bicycle brake devices, and the most common types are C clamp, V clamp and caliper. C clamp and V clamp are used to clamp brake sides of a wheel rim, and the brake device with caliper clamps a disc via brake pads to brake. This type of caliper is disclosed in TWD159805. The caliper can be categorized into three types according to the actuating ways: mechanical, semi-mechanical and hydraulic, and hydraulic caliper is popular because a braking force produced through hydraulic method is multiple times stronger than a pressing force by hand. In addition, the hydraulic caliper can actuate a braking movement and lower the speed quickly.

A caliper is composed of many components, and the components need to link up with one another, so it requires more time and effort to assemble the components. However, regarding a structure of the modern caliper, the components are usually strung together via a shaft so that the components can be coaxially arranged and comovable. With this type of assembling way, it is difficult to assemble the components, the components may get lost during the assembling process, and the caliper cannot be manufactured quickly.

The present invention has arisen to mitigate and/or obviate the afore-described disadvantages.

### SUMMARY OF THE INVENTION

The major object of the present invention is to provide a bicycle caliper, in which two caliper brake units can be assembled with each other in advance, and when in the final assembling step, a user only needs to put the whole caliper brake unit into a receiving portion of a base body. Therefore, it is easier and smoother to assemble the caliper.

To achieve the above and other objects, a bicycle caliper is provided, including a base body, two caliper brake units and two swinging units. The base body has a caliper braking area which is hollow and two receiving portions, the caliper braking area is for a disc to extend therein, and the two receiving portions are disposed by two sides of the caliper braking area; the two caliper brake units respectively include a rotating plate, a braking plate, at least one driving mechanism and a first connecting member which are integrally assembled along an axis, the rotating plate is rotatably positioned within the receiving portion about the axis, the first connecting member is movable along the axis and disposed through and connected to the rotating plate, the braking plate is screwed with the first connecting member to be in co-movement relation, the braking plate is located between the rotating plate and the caliper braking area, and the at least one driving mechanism is disposed between the rotating plate and the braking plate; the two swinging units respectively include a swinging portion for being driven from outside and a second connecting member, the swinging portion is connected to the rotating plate via the second connecting member to be in co-rotation relation. When the swinging portion is driven from outside, the at least one driving mechanism pushes the rotating plate and the braking plate to separate from each other and further abuts the braking plate to move toward the caliper braking area.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an embodiment of the present invention;

FIG. 2 is a partial breakdown view of FIG. 1;

FIG. 3 is a breakdown view of FIG. 2;

FIG. 4 is a drawing of a caliper brake unit of the embodiment of the present invention;

FIG. 5 is a drawing of the caliper brake unit assembled to a seat body of the embodiment of the present invention; and

FIGS. 6 and 7 are drawings showing movements of the embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

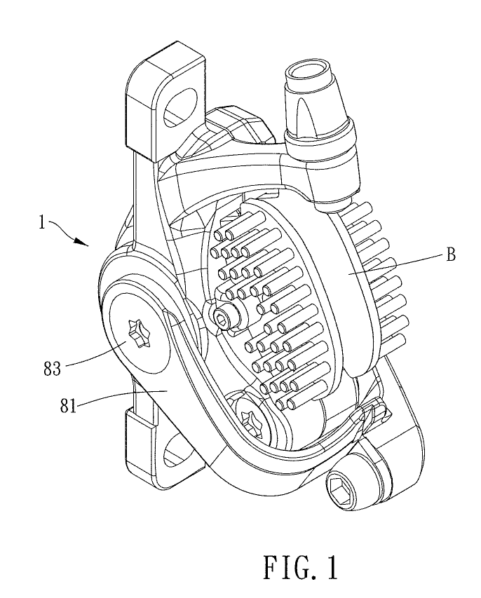

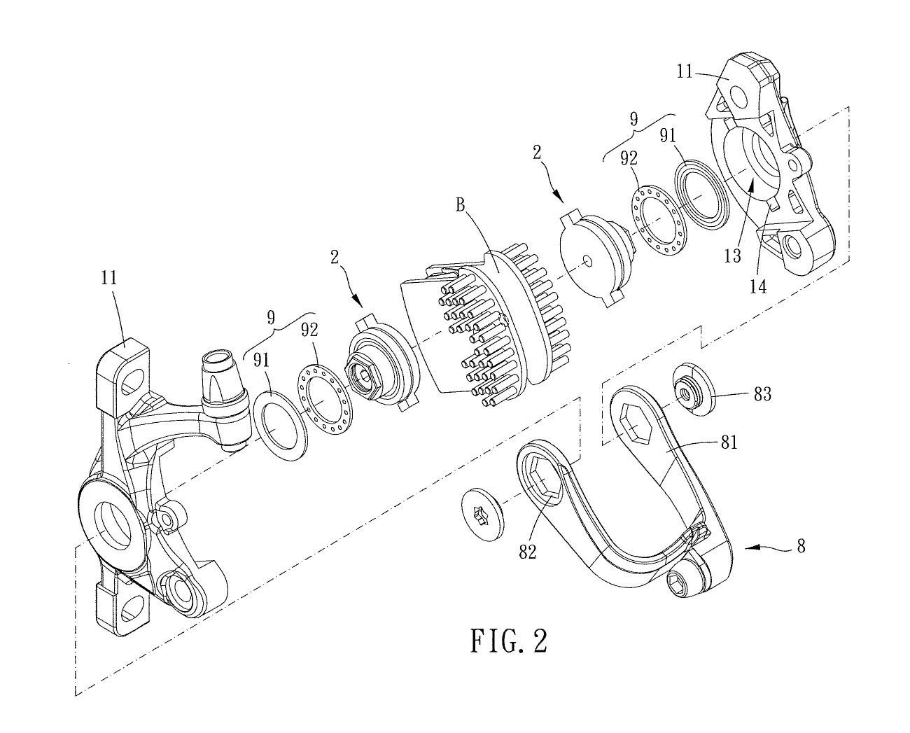

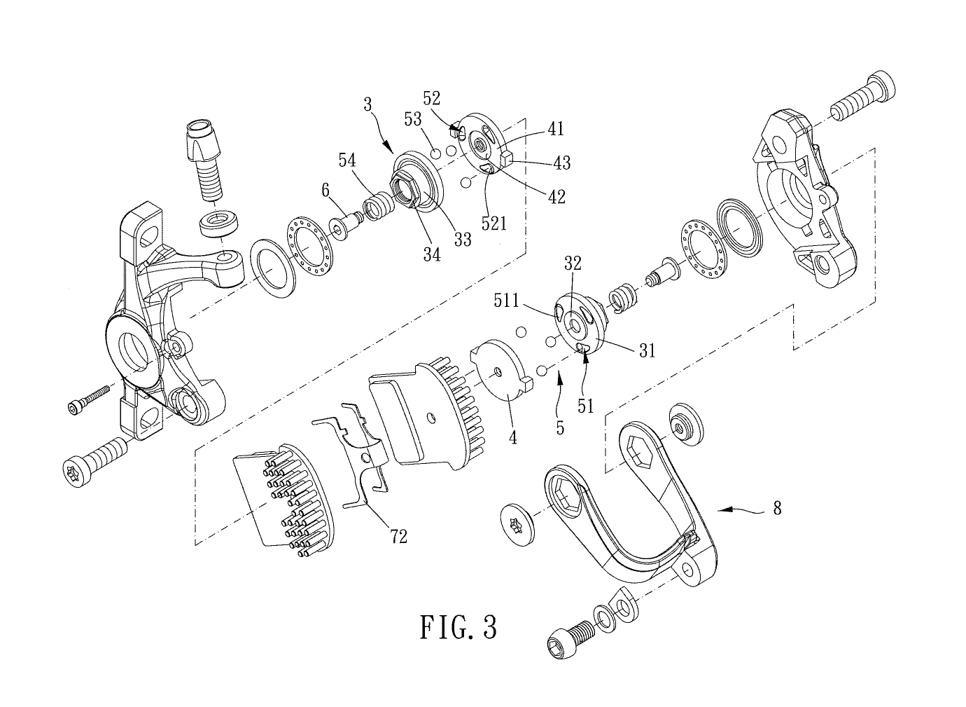

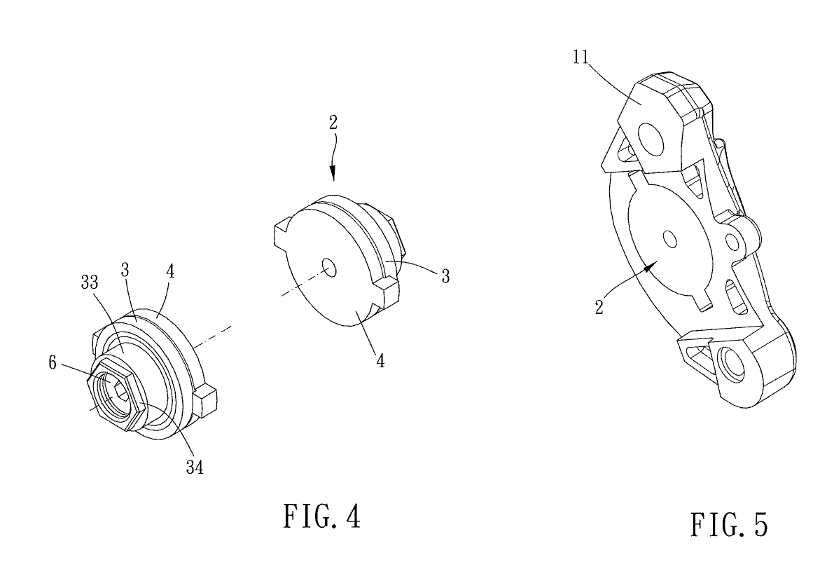

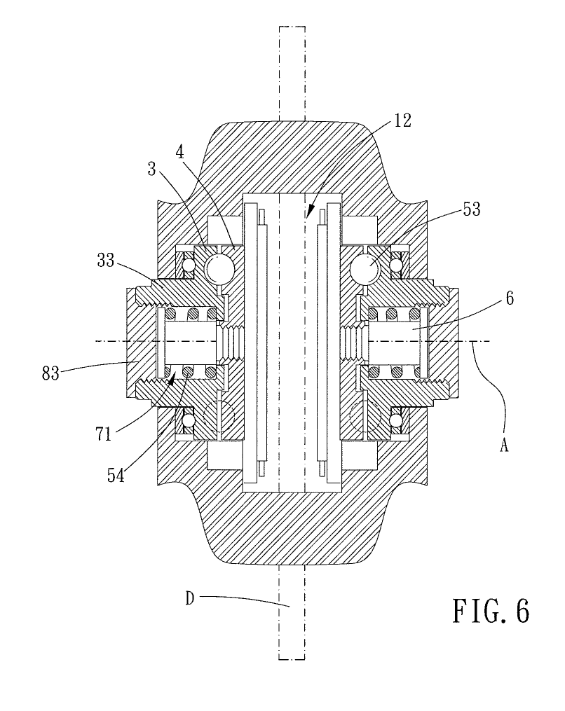

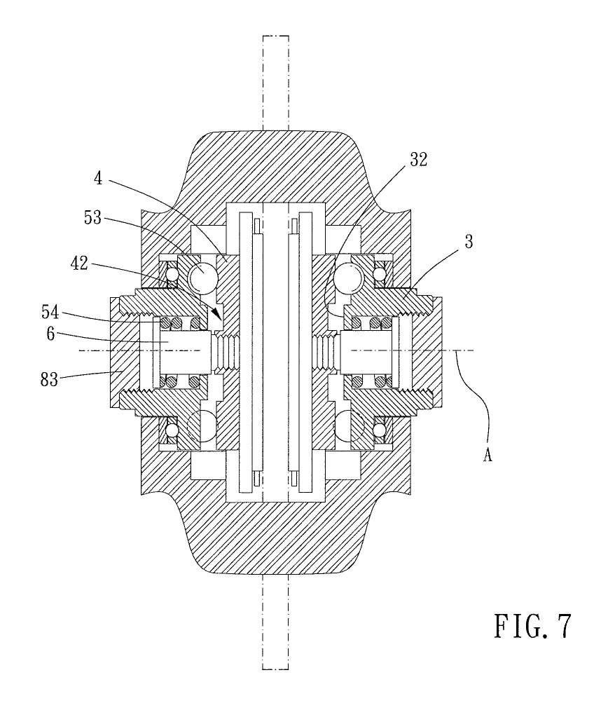

Please refer to FIGS. 1 to 7 for an embodiment of the present invention. A bicycle caliper includes a base body 1, two caliper brake units 2 and two swinging units 8.

Specifically, the base body 1 has a caliper braking area 12 which is hollow and two receiving portions 13, the caliper braking area 12 is for a disc D to extend therein, and the two receiving portions 13 are disposed by two sides of the caliper braking area 12. The two caliper brake units 2 respectively include a rotating plate 3, a braking plate 4, at least one driving mechanism 5 and a first connecting member 6 which are integrally assembled along an axis A, the rotating plate 3 is rotatably positioned within the receiving portion 13 about the axis A, the first connecting member 6 is movable along the axis A and disposed through and connected to the rotating plate 3, the braking plate 4 is screwed with the first connecting member 6 to be in co-movement relation, the braking plate 4 is located between the rotating plate 3 and the caliper braking area 12, and the at least one driving mechanism 5 is disposed between the rotating plate 3 and the braking plate 4.

More specifically, the base body 1 is formed by two seat bodies 11 connected with each other, each of the two seat bodies 11 has one said receiving portion 13 and further has two position-restricting slots 14, each of the two position-restricting slots 14 extends linearly along the axis A and communicates with the receiving portion 13 lateral to the axis A, the braking plate 4 further has two position-restricting portions 43, and the two position-restricting portions 43 are partly movably position-restricted within the two position-restricting slots 14 to ensure that the braking plate 4 is able to move linearly. In addition, a number of the at least driving mechanism 5 is three, and the three driving mechanisms 5 are equi-angularly arranged about the axis A so as to evenly push the braking plate 4 to move. Furthermore, the two swinging units 8 respectively include a swinging portion 81 for being driven from outside and a second connecting member 83, the swinging portion 81 is connected to the rotating plate 3 via the second connecting member 83 to be in co-rotation relation. When the swinging portion 81 is driven from outside, the at least one driving mechanism 5 pushes the rotating plate 3 and the braking plate 4 to separate from each other and further abuts the braking plate 4 to move toward the caliper braking area 12.

It is to be noted that through assembling the rotating plate 3, the braking plate 4, the at least one driving mechanism 5 and the first connecting member 6 together to form the caliper brake unit 2, a number of components need to be assembled in the following steps are greatly decreased, and it is easier to assemble the components. In the following assembling steps, an assembler only needs to put the caliper brake unit 2 which has already been assembled into the receiving portion 13 and to arrange the second connecting member 83 through the swinging portion 81, the seat body 11 and the caliper brake unit 2 to connect the swinging portion 81, the seat body 11 and the caliper brake unit 2, then the whole assembling process of the bicycle caliper is finished. In this way, the assembling process is convenient and fast, and the assembler does not need to worry that any component may get lost. In addition, by assembling the caliper brake unit 2 in advance, the assembler can check connection and movement among the components of the caliper brake unit 2 to ensure preferable yield rate and product quality.

Preferably, the bicycle caliper further includes two bearing assemblies 9, each of the two bearing assemblies 9 includes a fixing seat 91 and a bearing main body 92, the fixing seat 91 abuts against an inner wall of the receiving portion 13, and the bearing main body 92 rollably abuts against and between the fixing seat 91 and the rotating plate 3. The bearing main body 92 can ensure that the rotating plate 3 rotates relative to the base body 1 smoothly and further ensure that the braking plate 4 can be immediately and promptly driven to move to brake.

More preferably, the two braking plates 4 are connected to two brake pads B, and when the swinging portion 81 is driven from outside, the two brake pads B move within the caliper braking area 12 for clamping and braking the disc D. A greater contact area between the brake pad B and the disc D helps to elevate braking stability and heat dissipation.

Even more preferably, two sides of a spring 72 are respectively connected to and between the two brake pads B, the spring 72 can ensure that there is a gap between the two brake pads B to prevent the two brake pads B from deviating relative the disc D after the two brake pads B are used for a period of time. Hence, the problem of uneven braking can be prevented.

For more detailed descriptions of the components and structure of the caliper brake unit 2: the rotating plate 3 has a first actuating face 31, the braking plate 4 has a second actuating face 41, the first actuating face 31 and the second actuating face 41 face each other, each said driving mechanism 5 includes a first guiding groove 51 and a roller 53, the first guiding groove 51 is disposed on one of the first actuating face 31 and the second actuating face 41, as viewed in a direction facing the first guiding groove 51, a first bottom face 511 of the first guiding groove 51 gradually tilts upward along a first direction, the roller 53 is arranged between the first and second actuating faces 31, 41, and a part of the roller 53 is slidably arranged in the first guiding groove 51. Therefore, when the rotating plate 3 rotates, the roller 53 slides relative to the first guiding groove 51 and further abuts against the braking plate 4 and the rotating plate 3 so as to drive the braking plate 4 to move relative to the rotating plate 3.

More specifically, each said driving mechanism 5 further includes a second guiding groove 52 which corresponds to the first guiding groove 51, the first guiding groove 51 is disposed on the first actuating face 31, the second guiding groove 52 is disposed on the second actuating face 41, as viewed in a direction facing the second guiding groove 52, a second bottom face 521 of the second guiding groove 52 gradually tilts upward along a second direction, the second direction is opposite to the first direction, and two opposite sides of the roller 53 are respectively slidably arranged in the first and second guiding grooves 51, 52.

It is to be noted that an annular flange 32 is protrusively formed on the first actuating face 31, the first guiding groove 51 is disposed on an outer circumferential side of the annular flange 32, an annular groove 42 is recessively formed on the second actuating face 41, the second guiding groove 52 is disposed on an outer circumferential side of the annular groove 42, the annular flange 32 is selectively engaged within the annular groove 42, and the first connecting member 6 is disposed through the annular flange 32 to be connected to the braking plate 4. With the annular flange 32 and the annular groove 42, the rotating plate 3 and the braking plate 4 can be engaged with each other more stably and will not interfere with each other on a direction perpendicular to the axis A so as to ensure an assembling precision.

In this embodiment, the rotating plate 3 further has a shaft post 33 disposed through the base body 1, the shaft post 33 extends along the axis A opposite to the braking plate 4, the swinging portion 81 is connected to the shaft post 33, and the first connecting member is movably disposed through the shaft post 33 and projects beyond the rotating plate 3 to be connected to the braking plate 4. Specifically, one of two ends of the shaft post 33 further has an engaging portion 34, a contour of the engaging portion 34 is hexagonal, the swinging portion 81 has an engaging hole 82 which corresponds to the engaging portion 34 in contour, and the engaging portion 34 is engaged into the engaging hole 82 so that the rotating plate 3 and the swinging portion 81 are in co-rotation relation. More specifically, the second connecting member 83 is screwed with an inner wall of the shaft post 33 and defines a receiving chamber 71 with an interior of the shaft post 33, and the first connecting member 6 is partly movably position-restricted in the receiving chamber 71.

Preferably, each said caliper brake unit 2 further includes an elastic member 54 which is received in an interior of the shaft post 33, and two ends of the elastic member 54 respectively abut against and between an inner wall of the shaft post 33 and the first connecting member so as to make the braking plate 4 move normally away from the caliper braking area 12. When the force from outside disappear, the elastic member 54 make the braking plate 4 return to an initial position to prevent the brake pad B from clamping the disc D continuously and getting stuck.

Given the above, the bicycle caliper takes assembling angle into consideration and changes arrangements of the components and structure. Through connecting the rotating plate, the braking plate, the driving mechanism and the first connecting structure integrally to from a single component (the caliper brake unit), a number of the components need to be assembled afterwards decreases, and it is quicker and easier to assemble the components.

While we have shown and described various embodiments in accordance with the present invention, it should be clear to those skilled in the art that further embodiments may be made without departing from the scope of the present invention.

What is claimed is:

1. A bicycle caliper, including:
a base body, having a caliper braking area which is hollow and two receiving portions, the caliper braking area being for a disc to extend therein, the two receiving portions being disposed by two sides of the caliper braking area;
two caliper brake units, respectively including a rotating plate, a braking plate, at least one driving mechanism and a first connecting member which are integrally assembled along an axis, the rotating plate being rotatably positioned within the receiving portion about the axis, the first connecting member being movable along the axis and disposed through and connected to the rotating plate, the braking plate being screwed with the first connecting member to be in co-movement relation, the braking plate being located between the rotating plate and the caliper braking area, the at least one driving mechanism being disposed between the rotating plate and the braking plate;
two swinging units, respectively including a swinging portion for being driven from outside and a second connecting member, the swinging portion being connected to the rotating plate via the second connecting member to be in co-rotation relation;
wherein, when the swinging portion is driven from outside, the at least one driving mechanism pushes the rotating plate and the braking plate to separate from each other and further abuts the braking plate to move toward the caliper braking area.

2. The bicycle caliper of claim 1, wherein the rotating plate has a first actuating face, the braking plate has a second actuating face, the first actuating face and the second actuating face face each other, each said driving mechanism includes a first guiding groove and a roller, the first guiding groove is disposed on one of the first actuating face and the second actuating face, as viewed in a direction facing the first guiding groove, a first bottom face of the first guiding groove gradually tilts upward along a first direction, the roller is arranged between the first and second actuating faces, and a part of the roller is slidably arranged in the first guiding groove.

3. The bicycle caliper of claim 2, wherein each said driving mechanism further includes a second guiding groove which corresponds to the first guiding groove, the first guiding groove is disposed on the first actuating face, the second guiding groove is disposed on the second actuating face, as viewed in a direction facing the second guiding groove, a second bottom face of the second guiding groove gradually tilts upward along a second direction, the second direction is opposite to the first direction, and two opposite sides of the roller are respectively slidably arranged in the first and second guiding grooves.

4. The bicycle caliper of claim 3, wherein an annular flange is protrusively formed on the first actuating face, the first guiding groove is disposed on an outer circumferential side of the annular flange, an annular groove is recessively formed on the second actuating face, the second guiding groove is disposed on an outer circumferential side of the annular groove, the annular flange is selectively engaged within the annular groove, and the first connecting member is disposed through the annular flange to be connected to the braking plate.

5. The bicycle caliper of claim 1, wherein the rotating plate further has a shaft post disposed through the base body, the shaft post extends along the axis opposite to the braking plate, the swinging portion is connected to the shaft post, and the first connecting member is movably disposed through the shaft post and projects beyond the rotating plate to be connected to the braking plate.

6. The bicycle caliper of claim 5, wherein each said caliper brake unit further includes an elastic member which is received in an interior of the shaft post, and two ends of the elastic member respectively abut against and between an inner wall of the shaft post and the first connecting member so as to make the braking plate move mormally away from the caliper braking area.

7. The bicycle caliper of claim 5, wherein the second connecting member is screwed with an inner wall of the shaft post and defines a receiving chamber with an interior of the shaft post, and the first connecting member is partly movably position-restricted in the receiving chamber.

8. The bicycle caliper of claim 1, wherein the base body is formed by two seat bodies connected with each other, each of the two seat bodies has one said receiving portion and further has two position-restricting slots, each of the two position-restricting slots extends linearly along the axis and communicates with the receiving portion lateral to the axis, the braking plate further has two position-restricting portions, and the two position-restricting portions are partly movably position-restricted within the two position-restricting slots.

9. The bicycle caliper of claim 1, further including two bearing assemblies, each of the two bearing assemblies including a fixing seat and a bearing main body, the fixing seat abutting against an inner wall of the receiving portion, the bearing main body rollably abutting against and between the fixing seat and the rotating plate.

10. The bicycle caliper of claim 4, wherein the rotating plate further has a shaft post disposed through the base body, the shaft post extends along the axis opposite to the braking plate, the swinging portion is connected to the shaft post, and the first connecting member is movably disposed through the shaft post and projects beyond the rotating plate to be connected to the braking plate; each said caliper brake unit further includes an elastic member which is received in an interior of the shaft post, and two ends of the elastic member respectively abut against and between an inner wall of the shaft post and the first connecting member so as to make the braking plate move normally away from the caliper braking area; the second connecting member is screwed with the inner wall of the shaft post and defines a receiving chamber with the interior of the shaft post, and the first connecting member is partly movably position-restricted in the receiving chamber; the base body is formed by two seat bodies connected with each other, each of the two seat bodies has one said receiving portion and further has two position-restricting slots, each of the two position-restricting slots extends linearly along the axis and communicates with the receiving portion lateral to the axis, the braking plate further has two position-restricting portions, and the two position-restricting portions are partly movably position-restricted within the two position-restricting slots; the bicycle caliper further includes two bearing assemblies, each of the two bearing assemblies includes a fixing seat and a bearing main body, the fixing seat abuts against an inner wall of the receiving portion, and the bearing main body rollably abuts against and between the fixing seat and the rotating plate; one of two ends of the shaft post further has an engaging portion, a contour of the engaging portion is hexagonal, the swinging portion has an engaging hole which corresponds to the engaging portion in contour, and the engaging portion is engaged into the engaging hole; the two braking plates are connected to two brake pads, and when the swinging portion is driven from outside, the two brake pads move within the caliper braking area for clamping and braking the disc; two sides of a spring are respectively connected to and between the two brake pads; a number of the at least driving mechanism is three, and the three driving mechanisms are equi-angularly arranged about the axis.
